(19) United States
(12) Patent Application Publication
(10) Pub. No.: US 2016/0117061 A1
(43) Pub. Date: Apr. 28, 2016

(54) SYSTEM AND METHOD FOR IMAGE BASED INTERACTIONS

(71) Applicant: MIWORLD TECHNOLOGIES INC., Toronto (CA)

(72) Inventors: Jeffrey Hodgart, Toronto (CA); Maciej Binder, Toronto (CA); Peter Scott, Toronto (CA)

(21) Appl. No.: 14/895,451

(22) PCT Filed: Jun. 2, 2014
(86) PCT No.: PCT/CA2014/050511

§ 371 Date: Dec. 2, 2015

Related U.S. Application Data
(60) Provisional application No. 61/830,530, filed on Jun. 3, 2013.

(51) Int. Cl. G06F 3/0482; G06T 1/00

(52) U.S. Cl. CPC G06F 3/0482; G06T 1/0007; G06T 2200/24

(57) ABSTRACT

An image based interaction system, method and computer readable medium are based on identifying each image with a unique and trackable identifier, and using the unique and trackable identifier to facilitate and anchor user interactions. The system allows a first user to upload an image that represents a good, a service, or a subject topic and one or more selected associated actions for the good, service or subject topic to a server computer. The server computer generates a unique and trackable identifier within the image and records the identifier and the one or more associated actions in memory. The image incorporating the unique and trackable identifier may be distributed by the first user or any third party. A second user viewing the image incorporating the unique and trackable identifier on a network linked computing device is provided with the one or more associated actions from the server computer.

### BACKGROUND OF THE INVENTION

1. Field of the Invention

The present invention relates generally to digital image processing, and more specifically image processing to enable user interactions such as social or economic interactions.

2. Description of the Related Art

Since the mid-90's social or economic interactions have increasingly relied on computer-mediated communications that occur via computer-mediated formats such as instant messaging, email, chat rooms, text messaging and the like. Most current computer-mediated communications are text based in both social and economic interactions.

Internet marketplaces are an example of thriving social and/or economic interactions made possible by computer-mediated communications. The Internet has allowed online marketplaces to grow rapidly by connecting buyers and sellers from disparate locations wishing to trade goods or services. Examples of internet marketplaces include eBay.com, Craigslist.org, Amazon.com, or Alibaba.com. Internet marketplaces are based on text based communications that may optionally be complemented by uploading images.

However, the adage of a picture being worth a 1000 words seems to hold true. Every 15 seconds 52000 photos are uploaded to Facebook, 3000 visits to Pinterest, 30000 Tweets, 1000 photos uploaded to Instagram, 375000 videos watched on YouTube, 525000 likes and comments attached to photos, videos and images on Facebook. Despite an incredible amount of visual content and conversation being shared, liked and viewed within a 15 second time frame, most are not being leveraged to facilitate user interactions.

Accordingly, there is a continuing need for systems and methods for image based interactions.

### SUMMARY OF THE INVENTION

In an aspect there is provided a system for providing one or more actions for an image, comprising:

a memory to store a unique code, an image incorporating the unique code, and one or more actions associated with the unique code;

an interface connected to a network configured to receive a request for the one or more actions, the request comprising information containing the unique code;

and

a processor configured to identify the one or more actions based on the information containing the unique code in the request and to send the identified one or more actions in response to the request.

In another aspect there is provided a system for providing one or more actions for an image, comprising:

an interface connected to a network configured to receive information containing an image and one or more actions relating to the image;

the processor configured to generate a unique code, incorporating the unique code into the image and associating the one or more actions to the unique code;

and

a memory to store the unique code, the image incorporating the unique code, and the one or more actions associated with the unique code.

In yet another aspect there is provided a system for providing one or more actions for an image, comprising:

a memory to store a plurality of user interface elements, each element representing an action;

a screen to display an image incorporating a unique code;

an interface connected to a network configured to receive information containing one or more actions associated with the unique code;

and

a processor configured to display a user interface element for each of the one or more actions at or near the image incorporating the unique code based on the information containing one or more actions associated with the unique code.

In a still yet another aspect there is provided, a system for providing one or more actions for an image, comprising:

an end-user computing device comprising a screen to display an image incorporating a pixel representation of a unique identifier and a first processor which isolates the image and calculates the unique identifier from the pixel data of the image;

a second processor communicative with the first processor through a network, the second processor configured to receive the unique identifier and return to the first processor information containing one or more predetermined actions associated with the unique identifier;

and

the first processor configured to display a user interface element for each of the one or more predetermined actions within a graphic overlay generated at or near the image incorporating the unique identifier.

In still further aspects there are provided, method and computer readable medium for providing the same.

### BRIEF DESCRIPTION OF THE DRAWINGS

FIG. 1 shows a block diagram describing an example of a first user selecting an image and related actions;

FIG. 2 shows a block diagram describing an example of processing of the image selected in FIG. 1;

FIG. 3 shows a block diagram describing an example of distribution of the image processed in FIG. 2;

FIG. 4 shows a block diagram describing an example a second user viewing and interacting with the image distributed in FIG. 3;

FIG. 5 shows a diagram representing an example of data flow between end-user computing devices and server computers of the image based interaction system; and

FIG. 6 shows a diagram representing an alternative example of data flow between end-user computing devices and server computers of the image based interaction system.

### DETAILED DESCRIPTION OF THE PREFERRED EMBODIMENT

An image based interaction system, or method for providing the same, is based on embedding each image with a unique and trackable code, and using the unique and trackable code to facilitate and anchor user interactions.

A typical user may be any individual or entity that wishes to sell, purchase, request information, provide information or execute any other action relating to a good, a service or a subject topic, including for example individual consumers, groups or associations of individuals, or businesses.

The system allows a first user to upload an image that represents a good, a service, or a subject topic and one or more selected associated actions for the good, service or subject topic to a server computer. The server computer embeds a unique and trackable code within the image and records the code and the one or more associated actions in memory. The image incorporating the unique and trackable code may then be distributed by the first user or any third party. A second user viewing the image incorporating the unique and trackable code on a network linked computing device is provided with the one or more associated actions from the server computer.

The system allows for portability of images to be distributed to any number of computing devices and any number of networked destinations, such as internet websites, while maintaining the ability for the second user to receive the one or more associated actions for the image.

Referring to the drawings, an example of the system will be described in the context of a first user and a second user interaction for illustrative purposes. In practice, the system can accommodate any number of user interactions including one-to-one, one-to-many, many-to-one and many-to-many.

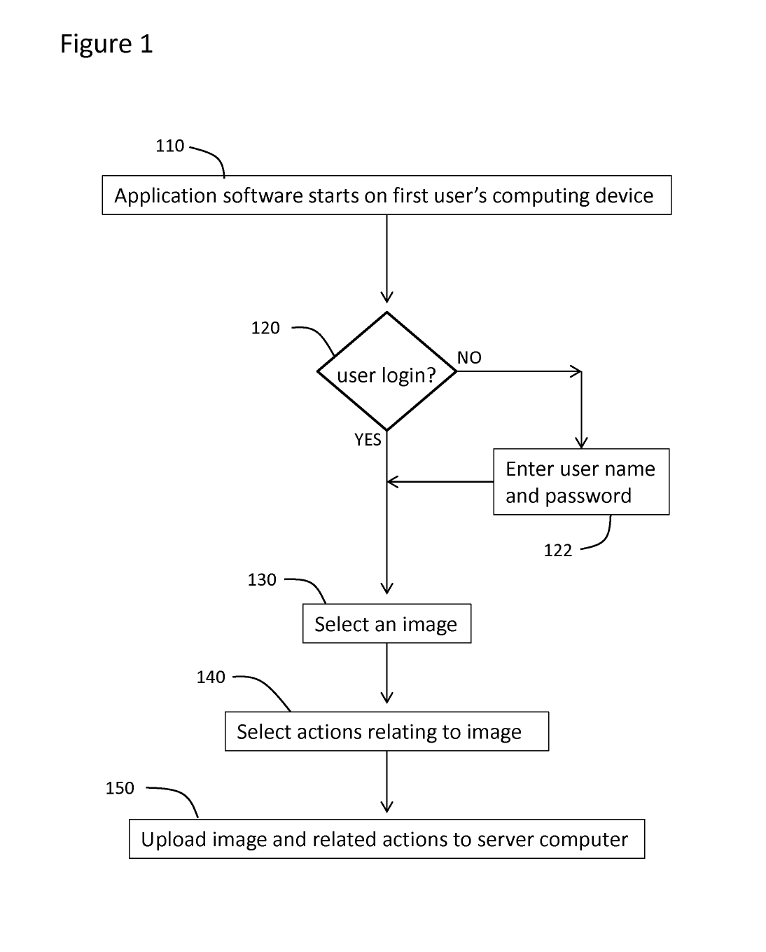

FIG. 1 shows a block diagram describing an example of a first user providing an image and selecting associated actions within the system. The first user may perform the steps shown in FIG. 1 using a personal computing device or using a website interface connected to a server computer. For convenience the steps are described in the context of the first user's personal computing device. Typically, upon start up of the first user's computing device an end-user interface application software previously installed on the computing device will start (110) and initiate a networked communication with a server computer of the system. The server computer will typically require login information (120) that may be provided by the application software in the form of a stored electronic data packet such as an electronic cookie. In the absence of automated login information provided by the application software, the first user is prompted to manually enter the login information (122) such as a user name and password. Once in a logged in environment the first user can access image upload and image processing functions. The first user selects an image (130) that represents an item for which the first user desires a social or economic interaction with a second user. The application software can provide a choice of selecting an image from a gallery stored in memory, allowing the first user to take a picture of the item with the computing device if it includes a digital camera, or inserting an image of the item captured by the first user using a separate digital camera. Other image sources such as scanned images may also be accommodated. Upon selection of an image, the first user selects actions to associate with the selected image (140) based on an array of action choices provided by the application software. Possible actions may encompass any social, economic or educational action such as selling, purchasing, marketing, sharing, or discussing a good, a service, or a subject topic including, for example, actions labeled Ticketing, Buy Now, Storefront, Deal-a-day, Sweepstakes, My Account, Trending, My Images, Live Auction, Webinars, Coupons, Video Streaming, Band Manager, Discounts, Analytics, Edit Suite, Fundraising, Donations, Shipping, Bid & Buy, Media Player and the like. One or more actions may be selected. Furthermore, for each selected action, the first user may specify action parameters. For example, for a selected Buy Now action, the first user may specify name, price, description variation and contextual narration, sharing peer to peer, and the like. As the selection of the image and the associated actions are completed the selected image information and the selected action(s) information may be synchronously or asynchronously uploaded (150) to the server computer using any convenient data transfer scheme. For example, to upload the image information a binary-to-text data encoding scheme such as Base64 may be useful as multiple HTTP requests for binary representation of images cannot be combined, while combination into a single request is possible by Base64 encoding. The selected action(s) information may be uploaded as an array using the JSON (JavaScript Object Notation) data interchange standard.

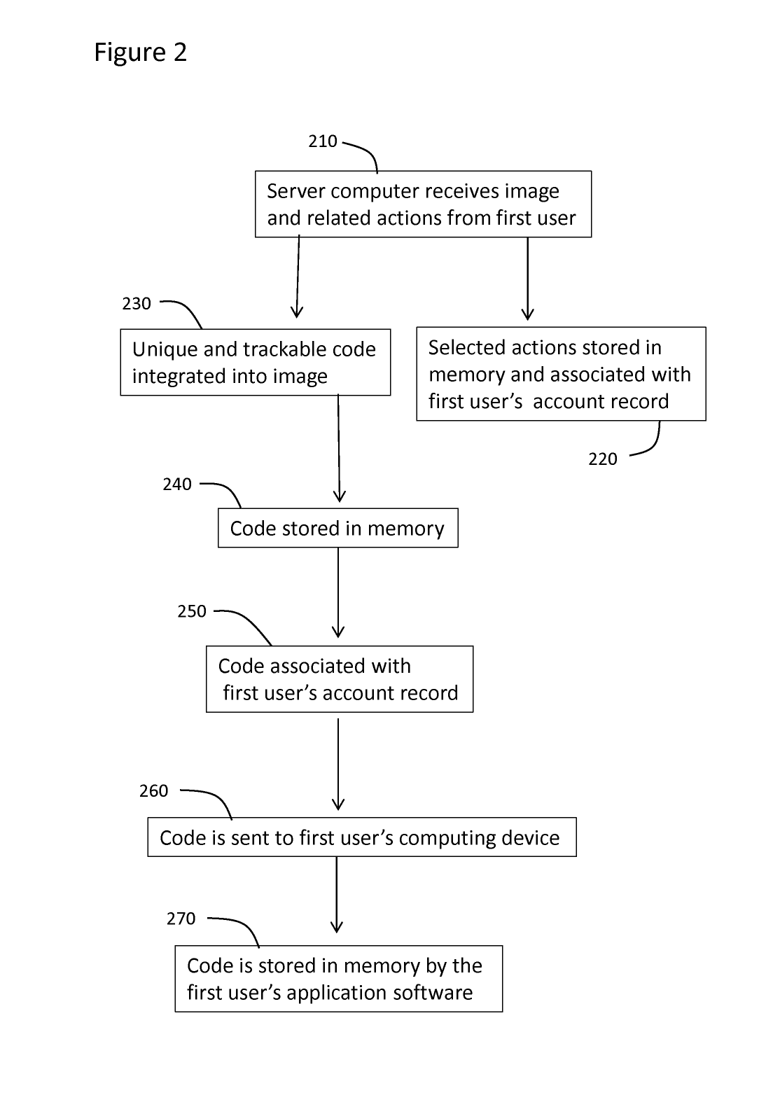

FIG. 2 shows a block diagram describing an example of processing steps performed by the server computer on the selected image and the selected associated action(s). The server computer receives (210) the selected image information and the selected action(s) information from the first user's computing device. Based on the information provided during the first user's login (120/122) the server computer can store the selected action(s) in memory and associate the selected action(s) with the first user's account record (220). The server computer can also process the selected image information to embed a unique and trackable code (230) and store the code-embedded image in memory. The unique and trackable code is also stored in memory (240) and associated with the first user's account record (250). The unique and trackable code is sent to the first user's computing device (260) and received by the application software and stored in memory (270).

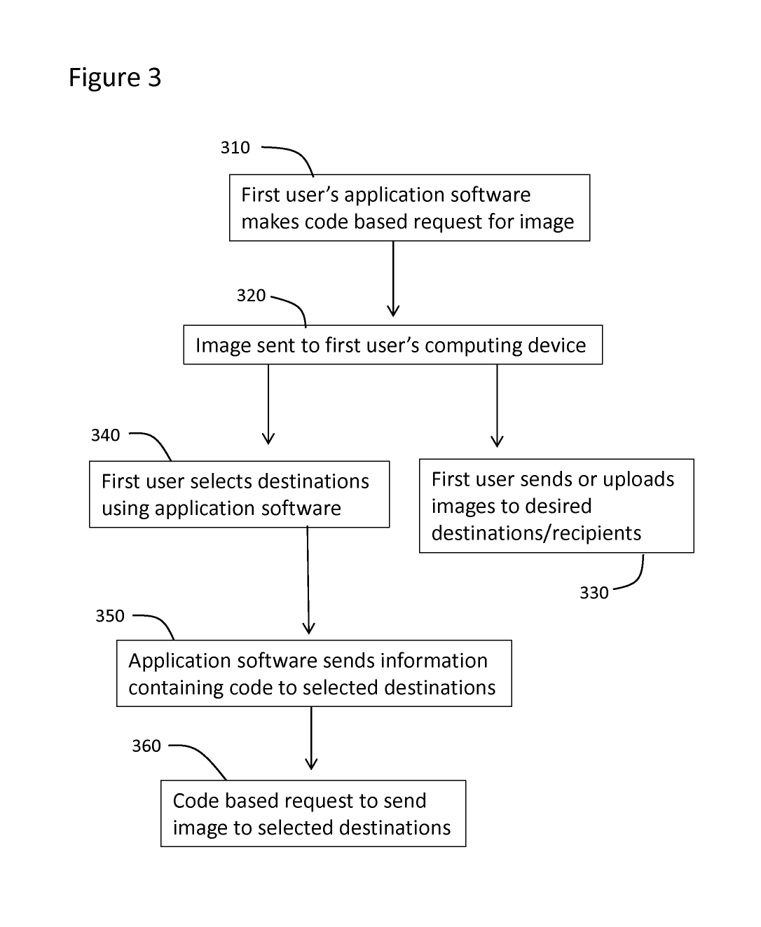

FIG. 3 shows a block diagram describing an example of steps performed by the system to allow the first user to distribute the code-embedded image. The first user's application software sends information including the unique and trackable code to the server computer (310), and based on this information the server computer returns the corresponding code-embedded image to the first user's computing device (320). The application software receives the code-embedded image and stores it in memory. Furthermore, a URL (uniform resource locator) may be established for the code-embedded image. The URL can include an alphanumerical representation of the unique and trackable code. The first user can then distribute the image using any convenient method. For example, the first user can upload a copy of the code-embedded image or the URL for the code-embedded image to websites (320) such as internet based chat rooms, social networks, marketplaces, and the like, or attach the code-embedded image to email or text messages sent to targeted or mass-messaged recipients. Alternatively, the application software can provide the first user with destination choices. Once destinations are selected (340) by the first user the application software can upload (350) the URL for the code-embedded image to the selected destination(s). Based on a URL request (360) from the selected destination(s) the code-embedded image can be sent from the server computer to the selected destination(s).

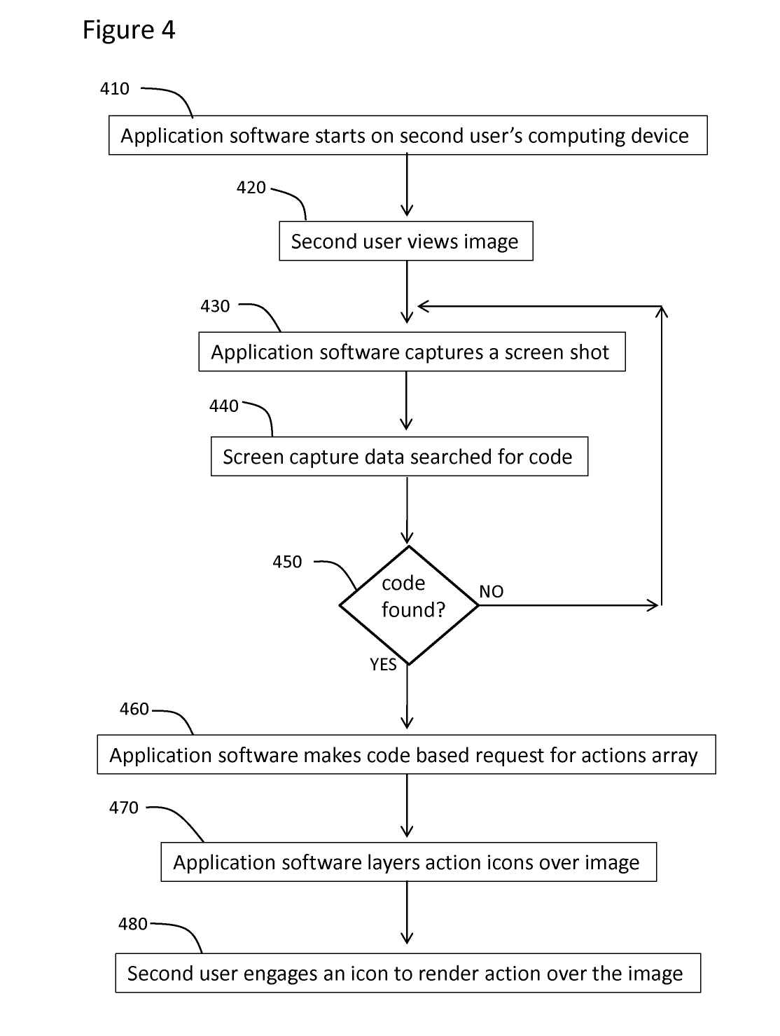

FIG. 4 shows a block diagram describing an example of steps performed by the system to allow the second user to interact with the code-embedded image. Typically, upon start up of the second user's computing device an end-user interface application software previously installed on the computing device will start (410) and initiate a networked communication with a server computer of the system. The server computer will typically require login information from the application software in the form of a stored electronic data packet such as an electronic cookie or manual entry of username and password. The application software monitors the display of the second user's computing device for appearance of the unique and trackable code. As the second user views images (420) the application software captures one or more screen shots (430). Since screen shots are captured, the images viewed by the second user may be any image including an image viewed using an internet browser or an image downloaded to the computing device and viewed using an image viewing software. Any convenient method of screen capture may be used including screen capture at time intervals and/or screen capture based on a change of the screen content. The application software searches the captured screen shot data for the unique and trackable code. Once the code is found (450) the second user's application software sends information including the unique and trackable code to the server computer (460) and receives in return the selected action(s) associated with the unique and trackable code and the first user's account record. The second user's application software then represents each selected action as a graphic overlay (470) at or proximal to the code-embedded image displayed on the screen of the second user's computing device. The second user may then may activate or execute any one of the first user's selected action(s) by engaging the corresponding graphic overlay using any interacting mechanism such as a pointer, keyboard stroke or voice command (480). If any further graphic overlays such as invoice images, twitter feeds, messenger dialogue boxes, and the like are needed to complete the selected action, these further graphic overlay can also be positioned at or proximal to the code-embedded image.

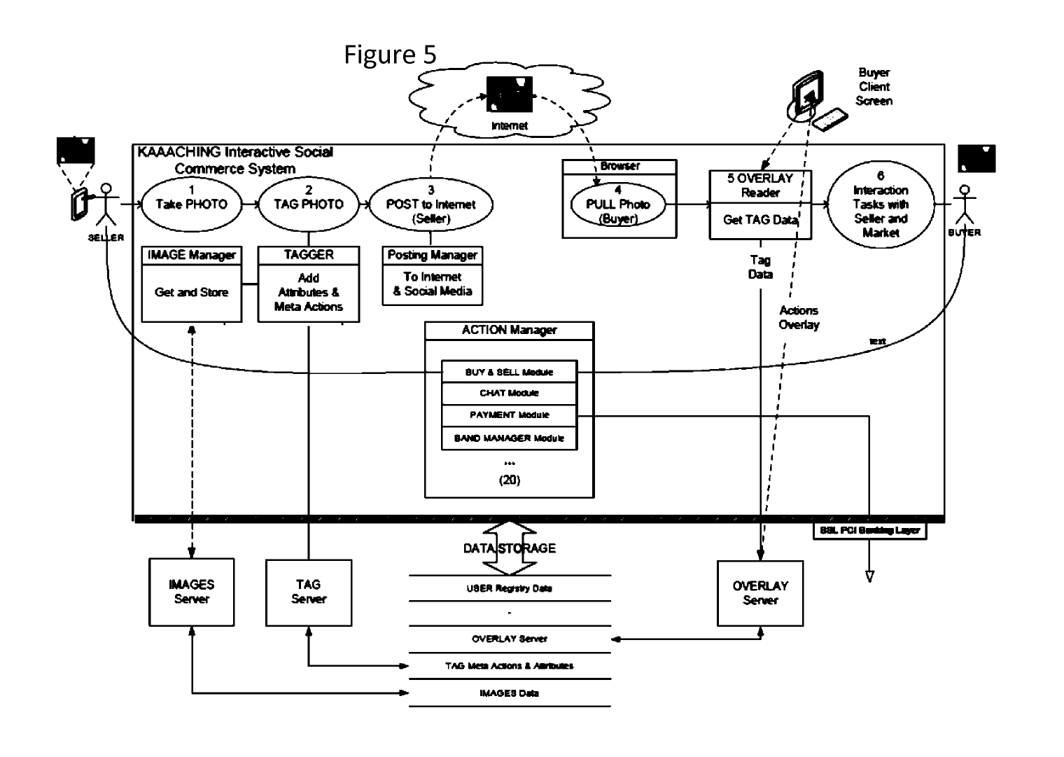

FIG. 5 shows a diagram representing information flow for a first user and second user interaction using the system. In this example, the first user is a seller and the second user is a buyer. The seller's mobile networked computing device comprises a digital camera and has the end-user interface application software installed. The seller wishes to sell an item. Using features provided by the application software the seller captures an image (1) of the item and selects actions to be associated with the item (2). The image information and the selected actions information is sent to dedicated server computers which are then processed and stored in dedicated storage systems. The image is processed to incorporate a unique and trackable code to yield a code-embedded image which is sent to the seller's computing device. The seller can then distribute the code-embedded image to desired internet destinations (3). Distribution of the code-embedded image may be facilitated by tools provided by the application software. The buyer may view a distributed copy of the code-embedded image through an internet browser running on the buyer's networked computing device (4). The buyer's computing device has the end-user interface application software installed. The application software captures and searches screen shots for the unique and trackable code (5). Upon identifying a unique and trackable code associated actions selected by the seller are retrieved from a dedicated server computer and storage system and each action is represented on the buyer's display as a graphic overlay at or near the code-embedded image. The buyer engages the graphic overlay to render the action over the code-embedded image (6). One-click purchasing and shipping is made possible by information available in the buyer's and seller's account records.

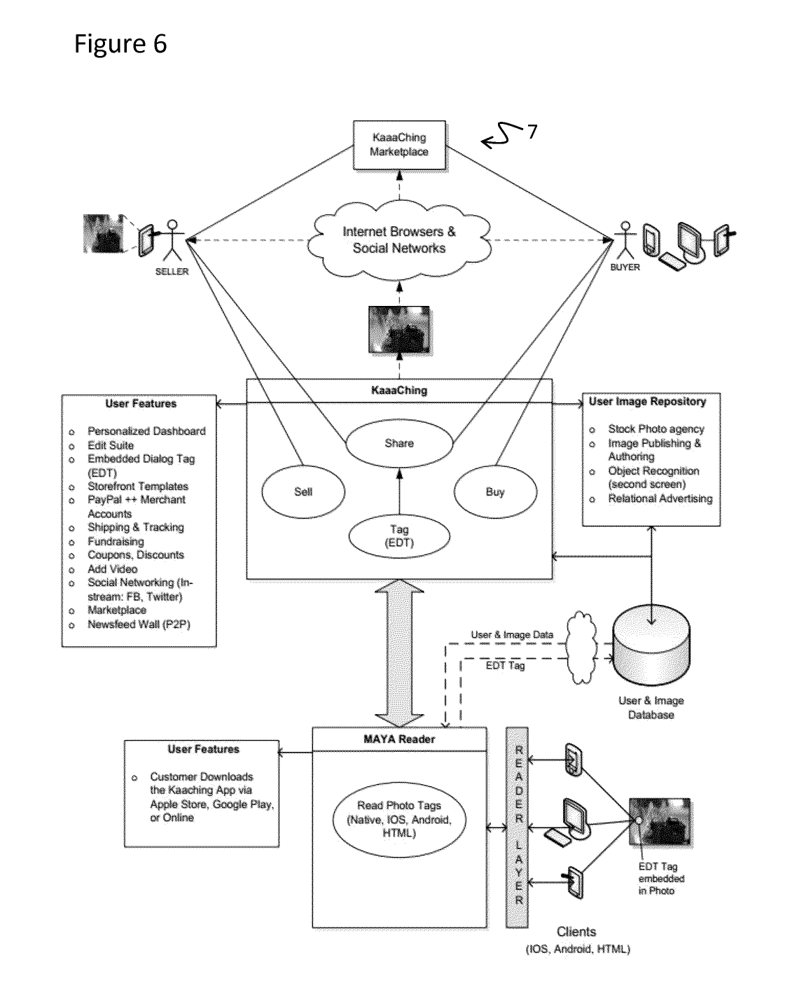

FIG. 6 shows another diagram representing information flow for a first user and second user interaction using the system. The first user is a buyer and the second user is a seller. FIG. 6 is similar to FIG. 5 with an added complexity of the system providing an internet based marketplace (7) for interaction of the buyer and seller in parallel to the code-embedded image interaction. Interaction through the internet based marketplace may optionally be through non-coded images.

In operation, the system enables user interactions that are anchored or centered around images. Thus, user interactions are image anchored or image centric. An image may be any still image such as photographs or any moving image such as videos. Users may come to expect any image available over the internet or viewed with a media player to be tagged with action overlays. The action overlay may remain dormant until a user engages an image or a specific portion of an image with an interactive mechanism such as a pointer (mouse, touchscreen, touchpad, infrared or laser remote controls, etc.), keyboard stroke or voice command. The subsequent action overlay can allow users any number of possible actions designated by the producer of the image. For example, a user watching a video comprising code-embedded image frames may engage the video image with a finger on a touchscreen when intrigued by a setting such as a restaurant. The user's application software may then pause the video and provide the user with action overlays which may include location, menus, business hours, twitter feed, etc. or any other action designated by the restaurant. The user can then choose to engage an action overlay with a finger. The system may include any other features for convenience such as video bookmarking that would allow the user to select image frames of interest during the video without engaging any action icons, so that the selected image frames may be viewed and action icons engaged at a delayed time after finishing viewing of the video.

By embedding unique and trackable codes in any number of frames in a video the system allows for content producers to maximize product placement revenue. For example, movie producers could embed codes for frames for all product placements. Product placement revenue may be added between theatrical and video release. Often an item in a popular movie unexpectedly influences the purchasing pattern of the viewers during a theatrical release. Prior to the video release the frames displaying the item may be embedded with a unique and trackable code allowing users to view, purchase and/or customize (color, style, size) the item by engaging corresponding action(s) for the unique and trackable code. For example, if a wine had gained popularity due to its inclusion in a movie, a user viewing the video version may engage an image frame containing the wine and could be presented with an icon representing a purchase action. Engaging the icon could automatically open a purchase screen. This purchase screen action prompted by the user could already be pre-populated with the user's shipping address referenced from the data stored in the user's account record facilitating an easy and rapid purchase.

An example of the system and method have been described above. Illustrative variants and modifications will now be described.

The system may accommodate any type of end-user computing device provided the computing device can be networked to the system and is configured to display images. For example, the computing device may be a desktop, laptop, notebook, tablet, personal digital assistant (PDA), PDA phone or smartphone, gaming console, portable media player, and the like. The computing device may be implemented using any appropriate combination of hardware and/or software configured for wired and/or wireless communication over the network. The computing device hardware components such as displays, storage systems, processors, interface devices, input/output ports, bus connections and the like may be configured to run one or more applications to allow, for example, an image to be isolated from a displayed document, extraction of unique identifiers from images, sending of the unique identifier to a remote computer, receiving actions and optionally action parameters associated with the unique identifier, representing the actions in a graphic overlay at or near the image, and/or a selection of an action in the graphic overlay. The terms end-user computing device and client computing device may be used interchangeably when the system is implemented in a client/server arrangement.

The server computer may be any combination of hardware and software components used to store, process and/or provide code-embedded images and actions associated with each code-embedded image. The server computer components such as storage systems, processors, interface devices, input/output ports, bus connections, switches, routers, gateways and the like may be geographically centralized or distributed. The server computer may be a single server computer or any combination of multiple physical and/or virtual servers including for example, a web server, an image server, an application server, a bus server, an integration server, an overlay server, a meta actions server, and the like. The server computer components such as storage systems, processors, interface devices, input/output ports, bus connections, switches, routers, gateways and the like may be configured to run one or more applications to, for example, generate a unique identifier for an image, generate a URL for the image, associate predetermined actions with the unique identifier, receive a request from an end-user computing device including the unique identifier, send the predetermined actions to the end-user computing device, and/or receive the selection of one or more of the predetermined actions from the end-user computing device.

While the system has been illustrated using a client/server implementation, the system may also accommodate a peer-to-peer implementation.

The network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Typically, the network will comprise a computer network that makes use of a TCP/IP protocol (including protocols based on TCP/IP protocol, such as HTTP, HTTPS or FTP).

The system may adapted to follow any computer communication standard including Extensible Markup Language (XML), Hypertext Transfer Protocol (HTTP), Java Message Service (JMS), Simple Object Access Protocol (SOAP), Lightweight Directory Access Protocol (LDAP), and the like.

Many different types of unique and trackable code schemes may be useful. For example, a code scheme may be based on a unix time appended a numerical or alphanumerical incremental series. A portion of each unique and trackable code may have a random or entropy component. Each unique and trackable code may optionally be obfuscated through an encryption function or a hashing function. Hashing functions provide a convenient compromise of security and speed. Examples of hashing functions include MD5 or any of the Secure Hash Algorithms SHA1, SHA2 (SHA224, SHA256, SHA384, SHA512) and SHA3. A unique and trackable code can be stored by the server computer and for each unique and trackable code an image URL containing the unique and trackable code may be generated and stored by the server computer. For example, if the code in alphanumerical format is d8e0e2804c273b66815d9742c040cf7f, then the image URL could be established as http://{SERVER_IP}/imgv/d8e0e2804c273b66815 d9742c040cf7f.png. A code in alphanumeric format, particularly when encrypted or hashed, may be directly integrated into an image. However, in many instances a use of a pixel representation of the alphanumeric code will be advantageous to produce a code-embedded image.

A pixel code such as a barcode or a digital watermark may be particularly useful for properties of resilience in withstanding distortion of an image as it is distributed to different destinations or converted from one image file type to another. Barcodes have achieved a reputation of reliability and are well supported by many sources of barcode generating and decoding software and standards. The traditional barcode is a linear (or 1-dimensional) barcode, while more recently the matrix (or 2-dimensional) barcode has gained popularity. Matrix barcodes have shown to be resilient to image distortions, with reports of coded information being retrievable after upto 60% of the barcode is damaged or distorted. Thus, the system will typically make use of a pixel code. The pixel code may be visible or invisible to human perception, but in all cases will be computer-readable.

U.S. Pat. No. 7,551,750 provides a list of benefits of visible and invisible digital watermarking. Digital watermarks are security devices which embed ownership, authorship, origin, distribution, or any other type of commercially-relevant or security-relevant information onto or within an image or object. Digital watermarking comprises an act of embedding information (referred to as a watermark) into the data set in an unobtrusive way so that the quality of the data set is not reduced, but the watermark can be extracted as the data set is being used. This is typically accomplished by placing the watermark into a noise band of the data set. In the context of a visual image such as a electronic photograph file, the noise band may include, for example, a few least significant bits associated with the color of each pixel of an image. In addition, a watermark may be embedded so as to be resilient to various manipulations of the data set such as, for example, photocopying, scanning, resizing, cropping and color manipulation. Digital watermarks may exist either in visible or invisible form. Invisible digital watermarks cannot be detected by the untrained naked eye, but must be detectable by some other mechanism, such as being machine-readable. Some benefits of digital watermarking in the context of image files include ownership determination, validation of intended recipient, non-repudiable transmission, deterrence against theft, meta level, content labeling, discouraging unauthorized duplication, authentication, document source identification, network patrolling (e.g., on Web), rights management (e.g., “copies remaining”) and the like.

The unique and trackable code may be any barcode. Barcodes are typically visible, but may be made less visible or invisible using digital watermarking or steganography techniques. For example, a less visible image barcode is achieved by having pixels of the barcode modified to be in a similar colour as their background. So, if the average box background color is for instance 178,15,220 then the barcode pixels may of a similar or same color value. Each pixel of a barcode can be compared to its nearest pixel within an incorporated image and an appropriate colour selected accordingly. Furthermore, barcodes may be made less visible by reducing the number of pixels used to represent the barcode. Regardless of the hiding or camouflaging technique used the barcode will remain visible to some extent even though it can blend in very well to its incorporated image. Azonmobile.com is an example of an online QR code generator that provides tools for blending or camouflaging QR codes within a designated image. Barcodes may be made invisible to the average human eye by using digital watermarking or steganography techniques described above, such as least significant bit steganography.

Barcodes are well known for graphically encoding information. Barcode formats are broadly categorized as 1-Dimensional, meaning information is coded in one direction, for example by varying the widths and spacings of parallel lines, or 2-Dimensional (or Matrix) that carry information in two directions: vertically and horizontally. Accordingly, 2-D barcodes are capable of holding tens and even hundreds of times as much information as 1-D bar codes. For example, a popular 2-D barcode format, Denso Wave's QR Code, can hold more than 7,000 digits or 4,000 characters of text, whereas even complex 1-D barcodes typically hold less than 50 characters. Another well known advantage of 2-D barcodes also provide greater resilience for information retrieval after distortion or damage. Furthermore, 2-D barcodes may be made invisible within a code-embedded image using digital watermarking or steganography techniques. Accordingly, use of visible or invisible 2-D barcodes may be particularly well suited for generating code-embedded images where resiliency of the barcode to image damage, distortion, conversion or the like is desired.

Many examples of barcodes are currently in use. Examples of 1-D barcodes that encoded numeric data include Codabar, Code 11, EAN-13, EAN-8, Interleaved 2 of 5, MSI, Plessey, PostNet, UPC-A, or UPC-E. Examples of 1-D barcodes that encode alphanumerical data include Code 128, Code 39, Code 93 or LOGMARS. Examples of 2-D barcodes include PDF417, DataMatrix, Maxicode, QR Code, Data Code, Code 49, Code 16K, Aztec Code, DataGlyphs, Codablock, Color Construct Code, High Capacity Color Barcode, HueCode or WaterCode. Thus, the system may use existing barcode, watermarking or steganography techniques as needed to generate pixel codes for integration within images to produce code-embedded images. Furthermore, development of proprietary pixel codes using techniques of barcodes, digital watermarks, steganography or any combination thereof is also contemplated.

The system may accommodate a variety of barcode encoders (generators) and decoders. Barcode generators and decoders are widely available. Many open source barcode generators or decoders are freely available online. For example, ZXing (pronounced “zebra crossing”) is an open-source, multi-format 1D/2D barcode image processing library implemented in Java, with versions available for other languages such as Qt framework, C#, NET framework and related Microsoft Windows platforms. Zxing can be used to encode and decode barcodes on both end-user computing devices and server computers. Zxing currently supports several barcode formats including UPC-A, UPC-E, EAN-8, EAN-13, Code 39, Code 93, Code 128, ITF, Codabar, RSS-14 (all variants), RSS Expanded (most variants), QR Code, Data Matrix, Aztec and PDF 417. Another example, ZBar is an open source software suite for reading bar codes from various sources, such as video streams, image files and raw intensity sensors. Supported barcodes include UPC-A, UPC-E, EAN-8, Code 128, Code 39, Interleaved 2 of 5 and QR Code. Yet another example, a barcode reader (BCR SDK) and a barcode generator (BCG SDK) are commercially available from BarcodeVision (Netherlands). Supported barcodes include UPC-A, UPC-A P2, UPC-B, EAN-8, EAN-13, EAN-13 P2, EAN-13 P5, Code 39, Code 39 Full ASCII, Code 128A, Code 128B, Code 128C, Code 128, Codabar, PDF417, PDF417 Truncated, Micro PDF417, RSS, RSS Expanded, RSS Limited, RSS Bacode Q1, RSS Bacode Z2, RSS Stacked, RSS-14 Truncated, RSS-14 Limited, GS1 DataBar Expanded, GS1 DataBar, GS1 DataBar, GS1 DataBar Truncated, GS1 DataBar Limited, DataMatrix ECC200, DataMatrix ECC000-140, QR Code (Model 1), QR Code (Model 2), Micro QR Code, Aztec Code and Aztec Small. Still another example is SwiftDecoder sold by Omniplanar Inc. (USA). Still further examples of barcode encoders and generators are described in U.S. Pat. No. 5,053,609 (issued 1 Oct. 1991), U.S. Pat. No. 5,189,292 (issued 23 Feb. 1993), U.S. Pat. No. 6,321,986 (issued 27 Nov. 2001), U.S. Pat. No. 6,752,316 (issued 22 Jun. 2004), U.S. Pat. No. 7,412,089 (issued 12 Aug. 2008), or U.S. Pat. No. 8,050,502 (issued 11 Nov. 2011).

Decoding of code-embedded images may be accomplished by the end-user application software and/or the server computer. Typically, the end-user application software will capture a screen shot. Analysis of the screen capture to detect a code-embedded image may be performed by the end-user application software or by the server computer. Similarly, decoding of the code-embedded image may be performed by the end-user application software or by the server computer. When an embedded pixel code is used the system will require a screen capture to occur prior to decoding the code-embedded image. Any convenient existing screen capture technique may be used including, for example, techniques described in U.S. Pat. No. 6,662,226 (issued 9 Dec. 2003), U.S. Pat. No. 7,016,547 (issued 21 Mar. 2006), U.S. Pat. No. 8,271,618 (issued 18 Sep. 2012) or US Patent Publication No. 20060126817 (published 15 Jun. 2006).

The purpose of screen capture is to obtain the pixel data of an image. Thus, any technique that allows for automated identification of images and access to their pixel data may be useful. For example, algorithms found in automated image downloaders or automated image extractors may be useful.

Examples of obtaining a pixel data for an image include bordered or borderless recognition of images within screen captures as well as queries of Document Object Model (DOM) trees. In an example of border-based recognition an image is surrounded with a border so that a recognition mechanism can identify regions to search for embedded codes or to cut out for hashing according to inherent properties. A screenshot may be captured and a Sobel Filter applied to bitmap pixels of the screenshot followed by a non-linear filter, which makes border corners more visible, and a vertices detection filter. Those vertices are filtered by horizontal and vertical filter and then minimum and maximum width may be met. As an illustrative embodiment, operating a 10 pixel border works well.

In an example, of borderless recognition an image without any border is extracted. A Sobel Filter but separate for x and y axis followed by line filter to remove short lines. Canny filter and Hough Filter may be applied for an improved detection rate. Canny and Hough are applied separately to the input image and compared to Sobel and its following filter. Any other combination with any other conventional filter is also possible to improve a detection rate. Typically a detection rate of greater than 80%, more typically greater than 90% is acceptable.

The Sobel Operator or Sobel Filter, is used in image processing and computer vision, particularly within edge detection algorithms, and creates an image which emphasizes edges and transitions. It is named after Irwin Sobel, who presented the idea of an “Isotropic 3×3 Image Gradient Operator” at a talk at the Stanford Artificial Intelligence Project (SAIL) in 1968. Technically, it is a discrete differentiation operator, computing an approximation of the gradient of the image intensity function. At each point in the image, the result of the Sobel operator is either the corresponding gradient vector or the norm of this vector. The Sobel operator is based on convolving the image with a small, separable, and integer valued filter in horizontal and vertical direction and is therefore relatively inexpensive in terms of computations. On the other hand, the gradient approximation that it produces is relatively crude, in particular for high frequency variations in the image. The Kayyali operator for edge detection is another operator generated from Sobel operator.

The Canny edge detector is an edge detection operator that uses a multi-stage algorithm to detect a wide range of edges in images. It was developed by John F. Canny in 1986. Canny also produced a computational theory of edge detection explaining why the technique works.

The Hough transform is a feature extraction technique used in image analysis, computer vision, and digital image processing. The purpose of the technique is to find imperfect instances of objects within a certain class of shapes by a voting procedure. This voting procedure is carried out in a parameter space, from which object candidates are obtained as local maxima in a so-called accumulator space that is explicitly constructed by the algorithm for computing the Hough transform. The classical Hough transform was concerned with the identification of lines in the image, but later the Hough transform has been extended to identifying positions of arbitrary shapes, most commonly circles or ellipses. The Hough transform as it is universally used today was invented by Richard Duda and Peter Hart in 1972, who called it a “generalized Hough transform” after the related 1962 patent of Paul Hough, U.S. Pat. No. 3,069,654 (issued 18 Dec. 1962).

Many other filters exist and may be used to detect and isolate images and their pixel data from a screenshot capture.

Images may also be detected and their pixel data obtained without using a screen capture. For example, a browser addon solution with a program running as a browser extension can detect all image elements presented in a webpage (within a DOM tree) via JavaScript each time a viewport is created or changed. As an example, a JavaScript query of getElementsByTagName(‘img’) produces an array that can be run against a function which determines if an image is within the viewport resulting in a new array with images visible to the user. In this example, a hash of each image may also be calculated using JavaScript.

Any other convenient method may be used to extract images and gain access to their pixel data including query of an HTML, XHTML, XML or Cascading Style Sheet (CSS) format.

Any convenient decoding technique may be used for decoding visible or invisible pixel codes from a code-embedded image. Each code-embedded image may hold a common identifier and a unique code. The common identifier and the unique code may be placed in a fixed and predetermined spatial orientation relative to each other. Similar to the unique code, the common identifier may be visible or invisible. The common identifier may be a logo that is visible or invisible. Decoding of visible pixel codes are widely available in both free and commercial implementations as has been described above.

An example of an invisible pixel code identifying technique is now described. By using visual pattern search of screen captures, a logo may be identified and its dimensions determine the size of an image to be captured and passed onto a processing routine for decoding a unique invisible pixel code. To identify the unique invisible pixel code, the captured image's color space is transformed from RGB to HSV (hue, saturation, value). The plane of the value is scaled horizontally and vertically to the multiple of 8 so that it can then be divided without a remainder. For example, 8×8=64 regions of same dimensions. For each of those regions an average pixel value is calculated (average luminance). This creates a chain of 64 values which range 0-255. Then a difference of the 64 values is calculated which returns 63 numbers of which some are negative, some positive depending on the difference in brightness between those blocks. Calculating one by one produces a control sum. If the difference is equal to or greater than 0 the bit is set to 1 and moved to the left . . . and so on 63 times. For example, differences of 10 . . . −5 . . . 1 . . . 3 yield bits of 1011. For the bits a crc32 checksum may be calculated and becomes a basic identifier for an image. In very rare cases 2 different images could produce the same checksum. A flag would then be raised and additional RGB based checksum could be calculated and appended to the HSV checksum. A moderator could check whether the images are simply duplicates. The advantage of this unique invisible code is that it uses an inherent property of the pixel data of an image and does not require altering an image to embed a code. Both the logo and unique invisible code identifying procedures can be accomplished using OpenCV (Open Source Computer Vision Library) which is a library of programming functions for real-time image processing and computer vision, developed by Intel, and now supported by Willow Garage and Itseez. Furthermore, an image may be identified by inherent properties of the pixel data of an image without any incorporation of a logo. Repeating the above example without a logo, the pixel data of the image can be analyzed to determine an appropriate grid with an appropriate box size for each box within the grid. For an average image size used in websites a grid of 8 by 8 to split an image into 64 blocks provides a functional solution. The image is desaturated (turned into a greyscale) prior to being broken down into blocks. For each block an arithmetic average luminance is calculated providing a natural number in range 0-255. The average luminance values for the 64 blocks are used to generate a 64 bit hash of an image (identifier) which gives a number of 2⁶³ possibilities. The hash is stored in a database and associated with a data record for the image including one or more predetermined actions for the image. When an end-user wishes to engage an image the hashing algorithm processes the image in the same way as described above and then queries the database to find out whether it stores the given hashes. If it does then a protocol is used to retrieve actions associated with a given hash and therefore image. Subsequently it renders appropriate action on the image in form of a graphic overlay. Functions which make hashing and recognition possible can be resistant to overall luminance change, color depth change, resize, resample, format change, quality change and other modifications. In other words the hash can survive with quite a lot of damage being applied to an image. A hashing function is not limited to using average luminance, but may include any pixel variable possible including hue, saturation, rgb etc. Furthermore, a hashing function is not limited to using an 8×8 grid, as the grid may be smaller for smaller images and larger for bigger images. Hashes may be prepended with identifiers indicating grid size and or pixel variable in use. Of course, multiple hashes, each using a different grid size and/or pixel variable, may be used for the same image to enhance robustness of identifying the image.

Many other procedures for identifying common pixel identifiers and unique invisible pixel codes may be developed, and may be used alone or in combination in the context of the system. Techniques of barcoding, digital watermarking, steganography or any combination thereof may be incorporated into such procedures. Thus, the system may accommodate visible to invisible codes to identify images, where visibility and invisibility is in reference to the capability of an average adult human eye. The system may also accommodate images identified by embedded codes, images identified by an inherent property of their pixel data or both images identified by embedded codes and images identified by an inherent property of their pixel data. Examples of coding of images with codes of varying visibility include visible code-embedded images, less-visible code-embedded images, invisible code-embedded images, or images without any embedded code identified by a unique hash of an inherent property of their pixel data.

The system may accommodate any type of still or moving image file including JPEG, PNG, GIF, PDF, RAW, BMP, TIFF, MP3, WAV, WMV, MOV, MPEG, AVI, FLV, WebM, 3GPP, SVI and the like. Furthermore, due to the screen capture and image analysis performed by end-user application software installed on the end-user computing device and/or the server computer, a still or moving image file may be converted to any other file without hampering the ability of the application software to identify an embedded code within the image. Thus, the system may accommodate any image file type and may function independent of a conversion from one file type to any other file type.

The selected actions associated with a unique and trackable code and the corresponding code-embedded image may be represented at or near the code-embedded image by any convenient form or user interface element including, for example, a window, a tab, a text box, a button, a hyperlink, a drop down list, a list box, a check box, a radio button box, a cycle button, a datagrid or any combination thereof. Furthermore, the user interface elements may provide a graphic label such as any type of symbol or icon, a text label or any combination thereof. The user interface elements will generally be spatially anchored or centered around the corresponding code-embedded image such that the user interface elements will typically appear at or near their corresponding code-embedded image. Otherwise, any desired spatial pattern or timing pattern of appearance of user interface elements may be accommodated by the system. Any number of selected actions may be associated with each unique and trackable code, and each action may be represented by one or more user interface elements as desired.

Any type of selected action may be associated with each unique and trackable code. The number and type of selected actions may vary with the specific use of the system and the end-user's choices and preferences. Examples of action types include Ticketing, Buy Now, Storefront, Deal-a-day, Sweepstakes, My Account, Trending, My Images, Live Auction, Webinars, Coupons, Video Streaming, Band Manager, Discounts, Analytics, Edit Suite, Fundraising, Donations, Shipping, Bid & Buy, Media Player and the like. Buy Now may be an action that allows a user to assign a price to each item and tag merchant data to a code-embedded image. Storefront may be an action that provides an offering of storefront templates allowing for the sale of multiple items with user specified features (images). Deal-a-day may be an action that provides a discounted price on goods or services for a limited time of typically 24 to 48 hours and typically in a group buying model. Sweepstakes may be an action providing consumer sales promotion, utilizing user specified incentives (i.e. draws, prizes). My Account may be an action that provides information regarding user demographic and registration details. Trending may be an action that allows a user to track trends through analytics. My Images may be an action that allows the user to view and edit image history and content. Live Auction may be an action that provides the ability to participate in real time, moderated product and/or service auctions. Webinars may be an action that provides broadcast feature, using a publicly available or proprietary media player. Coupons may be an action that allows for redemption and savings by attaching coupons to a purchase (i.e. barcodes, UPS, etc). Video Streaming may be an action that provides a proprietary video media player, allowing monetized tags for video, infomercials, lecture series, etc. Band Manager may be an action that provides a virtual “record company in a box”, allowing bands to represent themselves by providing bands with the ability to manage merchandising, ticketing, tour schedule etc within an image. Discounts may be an action that allows a user to apply a % discount to their item, for incentive purposes. Analytics may be an action that provides market research and data collection. Edit Suite may be an action that allows for interaction with images, assignment of tagged actions, etc. Fundraising may be an action that provides information from charitable and Not For Profit organizations. Donations may be an action that allows a user to tag images, specifying distinct denominations and information about a specific program or cause. Shipping may be an action that provides details for shipping logistics and fulfillment (i.e. price, weight, destination, carrier, etc). Bid & Buy may be an action that allows for bids on a time limited auction. Still many other types of actions may be tagged to a code-embedded image using the system. An action is useful for social, economic, or educational interactions may be provided using the system. In certain contexts the term action and meta-action may be used interchangeably. An action can be considered a meta-action when the action is related to a code-embedded image and is represented by a user interface element at or near the corresponding code-embedded image.

The system described herein and each variant, modification or combination thereof may also be implemented as a method or code on a non-transitory computer readable medium (i.e. a substrate). The computer readable medium is a data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

Variants and modifications described above are for illustrative purposes. Still further variants, modifications or combinations thereof are contemplated and will be recognized by the person of skill in the art.

1-75. (canceled)

76. A system for providing one or more actions for an image, comprising:
an end-user computing device comprising a screen to display an image incorporating a pixel representation of a unique identifier and a first processor which isolates the image and calculates the unique identifier from the pixel data of the image;
a second processor communicative with the first processor through a network, the second processor configured to receive the unique identifier and return to the first processor information containing one or more predetermined actions associated with the unique identifier; and
the first processor configured to display a user interface element for each of the one or more predetermined actions within a graphic overlay generated at or near the image incorporating the unique identifier.

77. The system of claim 76, wherein the unique identifier is encoded within a two dimensional pixel code embedded within the image.

78. The system of claim 77, wherein the two dimensional pixel code is not visible to the average human eye.

79. The system of claim 76, wherein unique identifier is a hash generated from an inherent property of the pixel data of the image.

80. The system of claim 79, wherein the inherent property of the pixel data is based on luminance, hue, saturation or RGB values.

81. The system of claim 76, wherein the first processor is configured to produce a screenshot capture and the image is isolated from the screenshot capture.

82. The system of claim 76, further comprising a third processor communicative with a second end-user computing device to establish the one or more predetermined actions.

83. A computer-implemented method for providing one or more actions for an image, comprising:
displaying an image incorporating a pixel representation of a unique identifier;
calculating, with a first processor, the unique identifier from the pixel data of the image;
sending the unique identifier from the first processor to a second processor through a network;
receiving from the second processor one or more predetermined actions associated with the unique identifier; and
displaying a user interface element for each of the one or more predetermined actions within a graphic overlay generated at or near the image incorporating the unique identifier.

84. The method of claim 83, wherein the unique identifier is encoded within a two dimensional pixel code embedded within the image.

85. The method of claim 84, wherein the two dimensional pixel code is not visible to the average human eye.

86. The method of claim 83, wherein unique identifier is a hash generated from an inherent property of the pixel data of the image.

87. The method of claim 86, wherein the inherent property of the pixel data is based on luminance, hue, saturation or RGB values.

88. The method of claim 83, wherein the first processor is configured to produce a screenshot capture and the image is isolated from the screenshot capture.

89. The method of claim 83, further comprising a third processor communicative with a second end-user computing device to establish the one or more predetermined actions.

90. A computer readable medium embodying a computer program for providing one or more actions for an image, comprising:
computer readable code for displaying an image incorporating a pixel representation of a unique identifier;
computer readable code for calculating, with a first processor, the unique identifier from the pixel data of the image;
computer readable code for sending the unique identifier from the first processor to a second processor through a network;
computer readable code for sending one or more predetermined actions associated with the unique identifier from the second processor to the first processor; and
computer readable code for displaying a user interface element for each of the one or more predetermined actions within a graphic overlay generated at or near the image incorporating the unique identifier.

91. The computer readable medium of claim 90, wherein the unique identifier is encoded within a two dimensional pixel code embedded within the image.

92. The computer readable medium of claim 91, wherein the two dimensional pixel code is not visible to the average human eye.

93. The computer readable medium of claim 90, wherein unique identifier is a hash generated from an inherent property of the pixel data of the image.

94. The computer readable medium of claim 93, wherein the inherent property of the pixel data is based on luminance, hue, saturation or RGB values.

95. The computer readable medium of claim 90, wherein the first processor is configured to produce a screenshot capture and the image is isolated from the screenshot capture.

96. The computer readable medium of claim 90, further comprising a third processor communicative with a second end-user computing device to establish the one or more predetermined actions.
